(19) United States
(12) Patent Application Publication
(10) Pub. No.: US 2002/0117325 A1
(43) Pub. Date: Aug. 29, 2002

(54) Flame resistant cable structure

(76) Inventors: Michael P. Mennone, Guilford, CT (US); Robert A. Gehm, Bethany, CT (US)

Correspondence Address: HAYES, SOLOWAY, HENNESSEY, GROSSMAN & HAGE, P.C., 175 CANAL STREET, MANCHESTER, NH, 03101-2335, US

(21) Appl. No.: 09/791,462

(22) Filed: Feb. 23, 2001

(51) Int. Cl. H01B 7/28

(52) U.S. Cl. 174/121 A

(57) ABSTRACT

A flame resistant electric cable capable of resisting temperatures in the neighborhood of 1000° C. comprising an electrical conductor comprising electrical wire and a tubular member made of a crosslinkable silicone elastomer which preferably includes a mineral filler. This is followed by a metal/polymer film shield enclosing the conductor which metal has a melting temperature above that temperature at which the elastomer undergoes crosslinking. Finally, the cable structure is surrounded within a polymer jacket, wherein the cable is observed to satisfy UL 2196 fire endurance testing requirements including hose spray without the need for additional mechanical protection.

### FIELD OF THE INVENTION

The present invention relates to an electric cable that is capable of resisting flame temperatures and water spray exposure with resulting mechanical vibration. More specifically, the present invention relates to the production of electric cable suitable for use in fire alarm systems as well as other related critical systems that must remain intact, i.e. retain circuit integrity, for a defined period of time during fire exposure.

### BACKGROUND OF THE INVENTION

One of the long-standing problems encountered in connection with the installation of cables in potential fire areas is that the cable insulation may collapse during the fire so that the conductor(s) will short-circuit. This problem and a variety of solutions are discussed in U.S. Pat. No. 4,547,626.

In addition, government regulations in numerous countries now specify that essential electrical circuits be protected in order to ensure that the electrical system maintain an operating condition during a fire to ensure the safety of persons inside the building and also to permit fire-fighting personal to be more efficient in controlling and extinguishing fires. For example, in certain locations, such as high rise buildings, a minimum amount of time is required so that all persons are alerted. Therefore, the electrical system during the fire must remain intact at least during such critical periods to allow the electrical fire alarms to continue in operation.

Along such lines, it has been established that some essential electrical circuits must be capable of operating for at least one hour, and in some other cases two hours or more to ensure safety of people. As noted, such systems include fire alarm systems, but may also include telephone systems, lighting systems, elevator systems, ventilation systems, water pumps, etc. It may also include voice systems to allow communication during a fire for evacuation of personnel or to allow fire fighters to talk to one another during a fire. Other essential circuits include control and power circuits for fireman's elevators and those fans and dampers which evacuate smoke or shut off smoke leaking into other areas. In addition, automatic door locks, emergency lighting, generators, fire pumps, strobes, smoke detectors, etc., may also similarly require appropriate insulation so that they will not collapse over a minimum period of time in a fire situation.

In U.S. Pat. No. 5,227,586, there is described a flame resistant electric cable which is said to be cable of resisting flame temperatures in the neighborhood of 1000° C. for at least two hours. Two embodiments are disclosed. In a first embodiment, there is shown an electrical cable having a pair of identically constructed conductors. Forming each conductor is a plurality of electrical connecting wires which are tightly held in a tubular member which is formed of a heat insulation material, preferably silicone rubber. The tubular member is helically wrapped with an outer layer of braided inorganic material; this inorganic material is either silica or ceramic. The two electrical conductors are then received within a tubular member which is formed of two helically wrapped layers of a heat barrier material such as mica. Surrounding the tubular member is a double helically wrapped layer of ceramic material providing a humidity barrier. An overall outer braided jacket preferably of fiberglass material, surrounds the double layer of ceramic material and provides mechanical protection to the cable.

In a second embodiment the '586 patent discloses a cable which is formed of three identically constructed conductors having components of conducting wires, silicone tubular member and braided inorganic material identical to the embodiment discussed above. The three conductors with ground wire are enclosed within a tubular member which may be a thin aluminum Mylar® (polyethylene terephthalate) shield, which, in turn is surrounded by an outer braided jacket of fiberglass material. The shield is said to provide an electrical barrier to the cable while the jacket provides mechanical protection.

In U.S. Pat. No. 5,705,774 a flame resistant electric cable is disclosed which is again said to resist flame temperatures in the neighborhood of 1000° C. As in the '586 patent above, two embodiments are presented. In the first embodiment, the cable is said to comprise at least two electrical conductors, each consisting of electrical wire, an extruded tubular member made of silicone elastomer surrounding the electrical wire, and an outer protective layer of braided inorganic material surrounding the tubular member. An extruded elongated tubular member made of silicone rubber surrounds the electrical conductors and is said to have a wall thickness of at least 0.030 inch for a cable wherein the overall diameter under the member is 0.200″. An overall outer braided jacket surrounds this tubular member of specified thickness.

In a second embodiment, the '774 patent discloses a flame resistant cable which comprises at least two electrical conductors each conductor consisting of an electrical wire, an extruded tubular member made of silicone elastomer that surrounds the electrical wire and an outer protective layer of braided inorganic material that surrounds the tubular member, a ground wire, an aluminum polyethylene terephthalate shield enclosing the electrical conductors and the ground wire, an extruded elongate tubular member made of silicone elastomer that surrounds the shield, the elongate tubular member having a thickness of at least 0.030 of an inch, and an overall braided jacket that surrounds the elongate tubular member.

In addition to the above disclosures, a variety of other efforts have been identified that similarly relate to the objective of preparing flame resistant cable material. Attention is therefore directed to the following U.S. Pat. Nos. 3,566,009; 3,576,388; 3,576,940; 4,150,249; 4,547,626; 5,173,960; 5,612,399; 5,739,473; and 6,051,642.

Furthermore, attention is directed to U.S. Pat. No. 4,405,425 entitled “Flame-Retardant Polysiloxane Elastomers”. This patent discloses a composition which is capable of being cured to an elastomer having improved flame-retardant and self-extinguishing properties comprising an organopolysiloxane, graphite and a compound selected from the group consisting of metal hydroxides, hydrates of metal oxides and mixtures thereof. In that regard, attention is also directed to U.S. Pat. No. 5,922,799 entitled “Organopolysiloxane Compositions Which Can Be Crosslinked To Give Flame-Resistant Elastomers”. Disclosed therein is the use of boron compounds chosen from the group consisting of boron carbide and metal borides mixed with non-reinforcing fillers, with the proviso that at least 75% by weight of the non-reinforcing fillers are heat-stable up to 1200° C., as flameproofing agents in organopolysiloxane compositions which can be crosslinked to flame resistant elastomers.

Attention is also directed to WO 98/43251 which relates to compositions for use as thermal insulation or barriers in articles that are required to function under transient elevated temperature conditions, such as experienced during a fire. The composition is recited in this disclosure to comprise at least two components, a first of the two components, at temperatures within a first lower temperature range, being ductile or flexible, but undergoing a physical or chemical change at temperature above the lower range but below an upper temperature limit required for fire resistance performance. The second of the two components is described as being dispersed within the first component, and the first component is said to be cohesive in the lower temperature range so as to retain the second component and stay substantially in place, the second component undergoing a physical or chemical change in transition to a second upper temperature range, the second component being ductile or flexible in the upper temperature range, and being cohesive so as to stay substantially in place at temperatures in the upper temperature range, the lower limit of the upper temperature range being below the upper temperature limit for fire resistance performance. The first component is said to include a polymer or reagents that may be reacted to form a polymer. The second component is said to include an oxide of aluminum, silicon or magnesium or boron or a combination of such oxides.

Reference is also made herein to EP 0708455 entitled “Flame Retardant Composition for Manufacturing of Electrical Cables with Insulation and/or Functioning Continuation”. Recited therein is a ceramisable flame-resistant composition containing an organosilicon polymer and a ceramisable filler, characterized in that it comprises a wetting agent for the ceramisizing filler. The ceramisizing filler is said to be an oxide, preferably aluminum oxide (Al₂O₃).

Attention is also directed to GB 2,130,785 entitled “Fire Resistant Electrical Cable”. Recited therein is an electrical cable comprising a plurality of conductive cores each having an insulating covering containing a silicone rubber, a layer of porous siliceaous material around the insulated core and adjacent the silicone rubber, an outer sheath of an insulating polymeric material.

While the above therefore provides a background regarding efforts to prepare flame resistant cable designs, it is also worth noting that the industry has progressed significantly with regards to testing requirements. In other words, efforts have also centered upon the development of testing standards that would provide improved testing protocols to standardize tests for fire resistant cable requirements. Along such lines, Underwriter Laboratories (UL) has recently developed a “Standard Test of Fire Resistive Cables, UL 2196”. UL has pointed out that the first edition of the Standard for Tests of Fire Endurance Cable (now retitled Fire Resistive Cable) was initially proposed via bulletin of Mar. 24, 1995. UL 2196 is now said to be intended to evaluate the circuit integrity of electrical cables during a period of fire exposure, and afterwards during exposure to a hose stream. Furthermore, in addition to a fire endurance test, and a hose stream test, an insulation resistance test is described, along with a leakage current test.

Accordingly, it is one object herein to improve and advance over the designs noted above, and provide a flame resistant cable structure that is ductile or flexible at the elevated temperature experienced in a fire and subsequent water spay exposure with resulting mechanical vibration and retains integrity so as to stay in place throughout the fire and subsequent water spray enabling it to continue to function as a thermal barrier. More specifically, it is an object herein to provide a cable structure that satisfies the UL 2196 test for a two hour duration and subsequent water spray. In addition, it is also a specific object to provide the flame resistant cable noted above, wherein the cable provides circuit integrity during attack by fire with subsequent water spray exposure with resulting mechanical vibration, is flexible and easy to install without the need for special tools or hardware. It is also an object herein to manufacture such cable with a much more basic design that is economical to fabricate (i.e., no expensive braided inorganic material) and which meets the survivability requirements of the 1999 National Fire Alarm Code (NFPA 72) and meets the water spray exposure with resulting mechanical vibration without additional barriers (such as conduit) being required.

### SUMMARY OF THE INVENTION

In broad aspect, the present invention relates to a flame resistant electric cable capable of resisting temperatures in the neighborhood of 1000° C. for a period of about two hours and satisfying UL 2196 performance testing requirements without the need for a layer of braided inorganic material and without a barrier (such as conduit) being required to pass water spray exposure. The electric cable comprises an electrical conductor comprising electrical wire and a tubular member made of crosslinkable silicone elastomer which surrounds the electrical wire. A metallic/polymer film shield or equivalent is then applied and a polymer resin serves as the outer layer.

### BRIEF DESCRIPTION OF THE DRAWINGS

FIG. 1 is a fragmented perspective view of an electrical cable made in accordance with the present invention.

### DETAILED DESCRIPTION

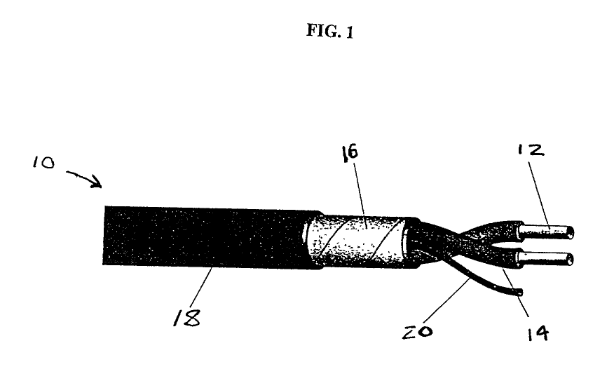

With attention directed at FIG. 1, illustrated generally therein is an electric cable 10, having a pair of conductors 12. Of course, in the context of the present invention, it can be appreciated that the cable structure herein would apply to either one or a plurality of conductors, or groups of conductors as may be required by a particular electrical application. Conductor size may vary, and can be made, e.g., in AWG size 12, 14 and 16. Conductor 12 preferably comprises solid annealed copper, and may also comprise a plurality of electrical conductor wires, again depending upon the given application. The copper conductor may have a coating (tin, nickel, etc.), although it is preferred that it be uncoated. The conductor 12 is held within a tubular member 14 formed of a heat insulation material, preferably a silicone elastomer material.

The silicone elastomer material 14 which may surround the conductor 12 is preferably a silicone elastomer material from the family of polymer resins known as polyorganosiloxanes that preferably contains an inorganic mineral additive. A preferred silicon elastomer is available from Wacker Slicones Corp. under as product ELR502/75. Furthermore, and in accordance with the present invention, at elevated temperatures, e.g, those temperatures encountered in the course of a typical of a fire, the silicon elastomer material herein melts and networks or crosslinks. Such process of crosslinking thereby serves to rigidize the material and protect the inner conductor layer in a fire situation. In other words, the crosslinking, together with the mineral additive, offers a level of structural integrity (including heat resistance) that preserves the conductor's ability to continue to function as a conductor. Reference is made to EP1006144 A2 which describes suitable compositions of silicone rubber combined with metallic oxides, such as magnesium oxide, aluminum oxide, tin oxide, calcium oxide, and barium oxide.

As also illustrated in FIG. 1, surrounding the conductors is a shield layer 16 of metal/polymer film, preferably a copper film layer of about 0.5-2.0 mils, which can vary upward or downward in 0.1 mil increment within such range. In that context, a particularly preferred range is, e.g., 0.6-1.2 mils copper. The preferred polymer film material is poly(ethylene terephthalate) material (PET), sold under the tradename “Mylar®”, at a thickness of 0.5-1.0 mils, which can vary upward or downward in 0.1 mil increments. In that regard, any non-halogenated polymer would be suitable, including, but not limited to polyesters, polyamide, aromatic polyamides, polyimides, polyethylene and ethylene-vinyl acetate copolymers. In a particularly preferred embodiment, a 1.0 mil Mylar® is used with a 0.6 mil copper.

While, preferably, the invention herein makes use of a copper/polymer film layer as described above, the invention herein extends to other metal/polymer film combinations, such as a steel/polymer film combination or metal without film backing such as copper tape in sufficient thickness, such as greater than 1 mil thick. Along such lines, it is preferred that the melt temperature of the metal is above the crosslinking process temperature such that the metal will remain generally intact to hold the silicon elastomer in place so that crosslinking may proceed as discussed earlier.

Finally, surrounding the conductors 12 is a jacket 18 is a non-halogenated thermoplastic or thermoset material, including thermoplastic olefin and thermoplastic elastomers. The thickness of the jacket is preferably 10-40 mils, more preferably 15-30 mils, as well as any value therebetween. By the term “non-halogenated” it is meant that for the particular thermoplastic or thermoset material at issue there are no identifiable halogens in the repeat unit or polymer chain structure. Preferably such polymers include polyolefin material which provides flexible performance characteristics. Such would include, polyethylene, ethylene-propylene copolymer, ethylene/1-octene copolymer, ethylene/1-butene copolymer, ethylene/styrene copolymer, ethylene/ethyl acrylate copolymer, and ethylene/methyl acrylate copolymer. Also included are those polymer resins produced by metallocene polymerization catalysts or “single-site” catalysis, including resins such as very low density polyethylene, which have densities below 0.90 g/cc.

The non-halongenated resin above may be employed with or without a suitable flame retardant, such as magnesium hydroxide, aluminum hydroxide, alumina trihydrate or mixtures thereof, with or without synergists (silicon gum, silicon oil, metal oxides, such as antimony oxide, iron oxides, copper oxides, zinc borate). In addition, the foregoing may or may not contain inert fillers and other additives. Furthermore, other zero halogen materials include Siltemp®, Ultem®, polyimides, polyesters, polyamide or other similar polymers. In one particularly preferred embodiment, the jacket 18 may comprise an ethylene/vinyl acetate copolymer resin, containing Al₂O₃-3H₂O.

Quite apart from the zero-halogen resins noted above, the jacket 18 may also include halogen resins, wherein the polymer chain contains a halogen atom covalently bonded thereto. In that regard, halogenated resins may be employed under those conditions where the halogen byproducts are not contained (such as by a conduit) and may escape into the surrounding air.

In addition, although not central to the inventive concept herein, also illustrated in FIG. 1 is a drain or ground wire 20, which is made of stranded copper. As noted above, the copper may be coated (tin, nickel, etc.), but preferably, it is uncoated. Furthermore, although not shown in FIG. 1, those skilled in the art will recognize that one could optionally include other inner jacketing material to the inventive construction, and tape instead of shield layer 16. Such a tape may be of a high temperature material such as mica, ceramic, Nomex®, silica or a combination thereof.

In accordance with the present invention, and as noted earlier, an important performance characteristic of the cable structure herein is its ability, in general to withstand temperatures in the neighborhood of 1000° for about a two hour duration and subsequent water spray exposure with resulting mechanical vibration. More specifically, it has been found that the cable structure formulation herein can meet the requirements of UL 2196, “Standard Tests for Fire Resistive Cables”. Pursuant to the requirements of UL 2196, whose requirements are incorporated by reference, a cable structure must in general provide a functional circuit throughout the required fire testing period of exposure, as evidenced by the illumination of a lamp connected to the conductor being tested. In addition, UL 2196 provides a mandatory “hose stream test” which is conducted on the fire test sample within 3 minutes after the fire test. Two levels of hose stream exposures are defined. Application of the lesser impact hose stream test is limited to fire alarm cable. Fire alarm cable must also comply with Article 760 of the National Electric Code, whose requirements are also incorporated herein by reference.

In accordance with the above, it has been found that the cable structure herein satisfies UL 2196 testing requirements for a two hour duration. Per the UL 2196 procedure, a cable (a single pair 16 AWG) was energized with about 120 volts AC RMS conductor to conductor (about 72 volts to ground). The cable maintains circuit integrity after exposure to 1010° C. after two hours. The cable was then hose sprayed with a 1.5 inch fog nozzle set at a discharge angle of 30 degrees with a nozzle pressure of 75 psi and a minimum discharge of 75 gpm with the tip of the nozzle 5 feet from the center of the exposed surface. The cable is then re-energized and demonstrated circuit integrity.

The cable was also tested with a typical high-end addressable fire alarm system available from Simplex, Inc. In this simulation, the maximum footage allowable for the particular device as configured at room temperature was connected to the fire alarm devices. This was a total of 2650 feet of two-conductor 16 AWG cable, of the present invention, for the smoke detectors and about 480 feet for the strobes. Of this, there was 30 feet of cable placed in a 10 foot section of conduit that was placed under a burner. The burner was only 10 feet long, so in order to simulate 30 feet of cable in a fire, the cables were laced through the conduit 3 times. The temperature was variable, but once stabilized, temperatures ranged from 1330° F. to 1440° F. on average with about 1800° F. to 1090° F. as maximum and minimum averages respectively. The cable was under test for about 105 minutes total, with over 60 minutes at the stabilized temperatures. About 5 smoke detectors were hooked up at once and about 10 strobes (light strobes). For the addressable system, high speed data was transmitted to the strobes and fire detectors and they functioned properly throughout the duration of the test.

The cable herein also passes the UL riser test per UL 1666, whose requirements are incorporated by reference. This test is a stringent large scale fire test for determining values of flame propagation height for electrical cables intended for vertical installation. The cable herein limits flame propagation to 12 feet, with an 850° F. maximum temperature at this height when exposed to an approximately 527,000 BTU per hour flame source.

With regards to the preferred method of manufacturing of the cable structure herein, those skilled in the art will recognize that conventional manufacturing techniques such as extrusion coating can be employed to prepare the cable structure defined herein. With respect to the preferred application of the copper/polyethylene shield 16, it has been found convenient to apply such shield over the conductor 14 by either helically winding or longitudinal application, and it generally has some type of overlap, except that butt lapping is also possible. More preferably, the shield is helical wound and has a 25% overlap. Such winding may be done at the cabling operation when multiple conductors are employed.

Finally, as can be seen from the above, one important aspect of the present invention, as compared to the prior art, is that the flame resistant electric cable herein achieves the recited performance noted above without the need for a layer of braided inorganic material, such as silica or ceramic. In other words, and with attention again directed at FIG. 1, the present invention uniquely and preferably relies upon only three (3) basic components surrounding a conductor to provide flame resistance and circuit integrity: a layer of silicon elastomer 14, a metallic/polymer film shield 16, and a polymer resin layer 18. The combination of these three components, without the need, e.g., of a layer or layers of braided inorganic material such as silica or ceramic, or a layer or layers of fiberglass, is therefore worthy of additional emphasis. Another important aspect of the present invention, as compared to the prior art, is that the flame resistant electric cable herein achieves the recited performance noted above including resistance to water spray exposure with resulting mechanical vibration without the need for additional mechanical protection (such as conduit).

What is claimed is:

1. A flame resistant electric cable capable of resisting temperatures of about 1000° C. for about 2 hours and satisfying UL 2196 performance testing requirements including hose spray without the need for additional mechanical protection or the need for a layer of braided inorganic material, comprising:
(a) an electrical conductor comprising electrical wire and a tubular member made of silicone elastomer surrounding said electrical wire, said silicone elastomer capable of crosslinking at elevated temperature;
(b) a metallic/polymer film shield enclosing said conductor; and
(c) a polymer resin.

2. The flame resistant electric cable of claim 1, wherein said metallic/polymer film shield enclosing said conductor is a copper/polymer film shield.

3. The flame resistant electric cable of claim 1, wherein said metallic/polymer film shield enclosing said conductor is a metallic/polyethylene terephthalate film shield.

4. The flame resistant electric cable of claim 1 wherein said metallic/polymer film shield is a copper/polyethylene terephthalate film shield.

5. The flame resistant electric cable of claim 1 wherein said metallic component of said metallic/polymer film shield is 0.5-2.0 mils thick.

6. The flame resistant electric cable of claim 1 wherein said polymer component of said metallic/polymer film shield is 0.5-1.0 mils thick.

7. The flame resistant electric cable of claim 4 wherein said copper is 0.6-1.2 mils thick and said polyethylene terephthalate is 0.5-1.0 mils thick.

8. The flame resistant electric cable of claim 7 wherein said copper is 0.6 mils thick and said polyethylene terephthalate is 1.0 mils thick.

9. The flame resistant electric cable of claim 1 wherein said metal/polymer film shield comprises a metal that has a melting temperature above that temperature at which said silicon elastomer undergoes crosslinking.

10. The flame resistant electric cable of claim 1, wherein said polymer resin is a non-halogenated polymer.

11. The flame resistant electric cable of claim 10 wherein said non-halogenated polymer is selected from the group consisting of polyolefines, polyesters, polyamides and polyimides.

12. The flame resistant electric cable of claim 10, wherein said non-halogenated polymer is selected from the group consisting of polyethylene, ethylene-propylene copolymer, ethylene/1-octene copolymer, ethylene/1-butene copolymer, ethylene/styrene copolymer, ethylene/ethyl acrylate copolymer, and ethylene/methyl acrylate copolymer.

13. The flame resistant electric cable of claim 10 wherein said polymer resin is an ethylene/vinylacetate copolymer containing Al₂O₃/3H₂O.

14. A flame resistant electric cable capable of resisting temperatures in the neighborhood of 1000° C. and satisfying UL 2196 performance testing requirements including hose spray without the need for additional mechanical protection, comprising:
(a) an electrical conductor comprising electrical wire and a tubular member made of crosslinkable silicone elastomer surrounding said electrical wire, said elastomer containing a mineral additive;
(b) a copper/polyethylene terephthalate film shield enclosing said conductor, wherein said copper film has a thickness between about 0.6-1.2 mils; and
(c) a non-halogenated polyolefin comprising an ethylene/vinylacetate copolymer containing Al₂O₃/3H₂O.

15. A flame resistant electric cable capable of resisting temperatures of about 1000° C. for about 2 hours and satisfying UL 2196 performance testing requirements including hose spray without the need for additional mechanical protection or the need for a layer of braided inorganic material, comprising:
(a) an electrical conductor comprising electrical wire and a tubular member made of silicone elastomer surrounding said electrical wire, said silicone elastomer capable of crosslinking at elevated temperature;
(b) a shield layer enclosing said conductor selected from the group consisting of mica, ceramic, aromatic polyamide, silica or mixture thereof; and
(c) a polymer resin
wherein said shield layer does does not melt at those elevated temperatures wherein said silicon elastomer is capable of crosslinking.
